(19) United States
(12) Patent Application Publication
(10) Pub. No.: US 2006/0216195 A1
(43) Pub. Date: Sep. 28, 2006

(54) Device and process for testing a sample liquid

(75) Inventors: Gert Blankenstein, Dortmund (DE); Ralf-Peter Peters, Bergisch-Gladbach (DE); Thomas Willms, Castrop-Rauxel (DE); Claus Marquordt, Dortmund (DE); Christian Schoen, Dortmund (DE)

Correspondence Address: ROBERTS, MLOTKOWSKI & HOBBES, P. O. BOX 10064, MCLEAN, VA, 22102-8064, US

(73) Assignee: Boehringer Ingelheim microParts GmbH, Dortmund (DE)

(21) Appl. No.: 11/340,837

(22) Filed: Jan. 27, 2006

(30) Foreign Application Priority Data
Jan. 27, 2005 (DE) 10 2005 003 961.8

(51) Int. Cl. G01N 31/22

(52) U.S. Cl. 422/57

(57) ABSTRACT

A device and a process for testing a sample liquid wherein the sample liquid flows laminarly by capillary forces over a flat side of a channel to completely filling a reaction area which has a soluble and/or reacting reagent on the flat side and defines a reaction volume of the sample liquid, the reaction volume being temporarily stopped in the reaction area for dissolving or reacting at least 90% of the reagent in the defined reaction volume of the sample liquid, and at least 90% of the dissolved reagent or a reaction product, after stopping, flows together with the reaction volume into the test area which is formed by the channel downstream of the reaction area, the sample liquid flowing with an at least essentially straight liquid front and/or at least essentially without a change in the flow cross section from the reaction area into the test area.

### BACKGROUND OF THE INVENTION

1. Field of the Invention

This invention relates to a device and process for testing a sample liquid, such as blood plasma, urine, saliva, or the like. More specifically, this invention is concerned with mirofluidic systems and devices in which capillary forces act and are especially decisive for operation.

2. Description of Related Art

To test a sample liquid, especially for determining blood sugar, blood lipids, enzymes or other values, so-called test filter strips which are made of paper, films, filters, membranes or the like are often used. Such test filter strips are made for sample charging and also assume transport functions. For example, the sample liquid is transported as a result of capillary forces in a fleece-like material in the test filter strip. The sample liquid can react with reagents which have been added beforehand, and for example, cause color reversal upon detection of the substance to be analyzed in the sample liquid. However, these test filter strips allow only a comparatively inaccurate, qualitative detection of an analyzed product.

Alternatively, microcapillary systems for testing a sample liquid are known. European Patent Application EP 1 201 304 A2 and corresponding U.S. Patent Application Publication 2004/0241051 A1, for example, disclose a microstructured platform for testing a sample liquid. The platform has a fill area, a test area and a channel system. The sample liquid can be taken up and delivered solely by capillary forces. In order to induce a less curved flow front and a uniform flow velocity, the known platform has delay structures along the edges of a wide, flat channel, especially in the test area. Furthermore, the sample liquid for the known platform, if necessary, can be stopped at a given location for a defined interval in order, for example, to enable a chemical reaction or a physical process, such as heating or cooling. However, European Patent Application EP 1 201 304 A2 and corresponding U.S. Patent Application Publication U.S. 2004/0241051 A1 are not concerned with a test which is as accurate as possible, especially a quantitative test, of a sample liquid.

### SUMMARY OF THE INVENTION

A primary object of this invention is to devise a device and a process for testing a sample liquid, such as blood, blood plasma, urine, saliva, or the like which, at low cost, enable a preferably quantitative test, especially determination of blood sugar, blood lipids, enzymes, or other values.

The aforementioned object is achieved by a device having a channel which holds and conveys the sample liquid by capillary forces and which has a flat side over which the sample liquid flows laterally or laminarly, a reaction area with a soluble or reacting reagent on the flat side, the reaction area being completely fillable with a sample liquid and thus a reaction volume or plug being definable by the sample liquid, a test area which is formed by the channel and which is downstream of the reaction area, a means for temporarily holding the sample liquid in the reaction area for dissolving and/or reacting with the reagent, and a means for producing a less curved or straight flow front of the sample liquid, wherein the reagent is at least 90% soluble in the defined reaction volume by the sample liquid or reacts with it, wherein the dissolved reagent or a reaction product of the reagent can be conveyed together with the reaction volume into the test area or the concentration of the dissolved reagent or of the reaction product within the reaction volume in the test area varies by a maximum 10%.

The object is also achieved by a process wherein the sample liquid flows laterally or laminarly by capillary forces over a flat side of the channel, completely fills a reaction area having a soluble or reacting reagent on the flat side, and in this way, defines a reaction volume of the sample liquid, wherein the reaction volume is slowed or temporarily stopped in the reaction area for dissolving or reacting with the reagent, and wherein the sample liquid flows with an at least essentially straight liquid front, or at least essentially without a change in the flow cross section, from the reaction area into the test area.

The combination of measures in accordance with the invention enables a much more accurate testing of a sample liquid, especially a quantitative determination of at least one substance to be analyzed in the sample liquid. The defined holding of the sample liquid in the reaction area establishes a reaction volume in which a reagent in the reaction area can be dissolved in a defined manner or with which the reagent can react. Then, the reaction volume with the dissolved reagent or reaction products is further conveyed from the reaction area into the test area, the lateral, at least essentially laminar flow and/or the at least essentially linear flow front of the sample liquid leading to low dispersion, therefore an at least essentially uniform concentration profile of the dissolved reagent or the reaction products being attainable in the reaction volume further delivered into the test area. Accordingly, within a defined time a much more accurate test, especially determination of values in the indicated sense, can take place.

For testing or determination, for example, complexes or compounds formed by the dissolved reagent and the analyzed substance which is to be determined can be bound in the test area by means of an immobilized detection chemical and then measured or detected for example optically. For example, the concentration of the analyzed substance in the sample liquid can be determined therefrom.

Another, also independently attainable aspect of this invention is to provide the reaction area, the test area and/or the channel with an at least essentially constant cross section and/or to make the height of the channel smaller than the width of the channel at least by a factor of 10 and/or to make the reaction area and/or the test area at most as long as wide or shorter.

The aforementioned measures are conducive to a quantitative test or biochemical tests. In particular, a plug-like motion or flow of the liquid and defined testing of the defined reaction volume are enabled and unwanted dispersion of the reaction volume is avoided. Other advantages are short test times, prompt reactions, short diffusion paths and/or short flow paths.

Other advantages, features, properties and aspects of this invention will become apparent from the following description of preferred embodiments with reference to the accompanying the drawings.

### BRIEF DESCRIPTION OF THE DRAWINGS

FIG. 1 is a schematic lengthwise section of part of a device in accordance with the invention filled partially with a sample liquid according to a first embodiment;

FIG. 2 is a schematic top view of the support of the unfilled device shown in FIG. 1;

FIG. 3 is a top view of the support of an unfilled device corresponding to FIG. 2 according to a second embodiment;

FIG. 4 shows a schematic cross section of the device according to the first embodiment taken along line IV-IV in FIG. 1;

FIG. 5 shows a schematic cross section of the device corresponding to FIG. 4 according to a third embodiment; and

FIG. 6 shows a schematic cross section of the device corresponding to FIG. 3 according to a fourth embodiment.

### DETAILED DESCRIPTION OF THE INVENTION

In the figures, the same reference numbers are used for the same or similar parts, corresponding or comparable properties and advantages being achieved even if a repeated description is omitted.

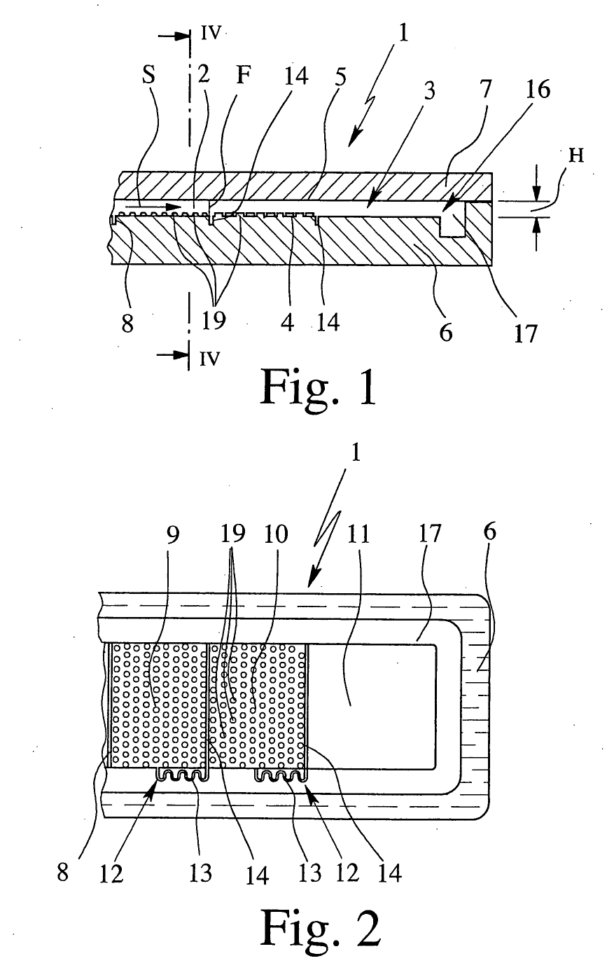

FIG. 1 shows in a schematic section a part of a first embodiment of a device 1 in accordance with the invention for testing a sample liquid 2, especially blood plasma or the like. The device 1 has a channel 3 which takes up and conveys the sample liquid 2 by capillary forces. The channel 3 is preferably bordered or formed by only two opposing, especially essentially flat surfaces or flat sides 4, 5.

The device 1 has a preferably plate-shaped support 6 and an assigned cover 7 between which the channel 3 is formed. In the illustrated embodiment, only the support 6 for forming the required microstructure is relieved and the cover 7 is flat, preferably at least essentially free of recesses. However, this can also be reversed, or if necessary, both the support 6 and also the cover 7 can be relieved and/or made with projections for forming the desired structures, and optionally, for holding chemicals, reagents, test means or the like (not shown). In particular, the device can also be a so-called microchip (platform with a microstructure).

FIG. 2 shows in a schematic top view the support 6 of the device 1 without a cover 7 and without the sample liquid 2. The channel 3 preferably has, directly in succession, an inlet, in the illustrated embodiment especially with a trough 8, a reaction area 9, a test area 10 and/or a collecting area 11.

If necessary, metering of the sample liquid 2 (not shown) can take place into the channel 3 or in the channel 3, especially upstream from the inlet, such as is described, for example, in 2004/0209381.

The device 1 preferably has only a single channel 3. Here, the channel 3 should be understood in the sense of an individual capillary. However, if necessary, the channel 3 can lead or branch in different directions or to different areas. In the illustrated embodiment, the sample liquid 2 flows preferably exclusively by capillary forces into the channel 3 or in the channel 3 in the flow direction S, as indicated in FIG. 1. However, the sample liquid 2 can also be conveyed through the channel 3 additionally or alternatively, for example, by pressure.

The channel 3 preferably has an essentially rectangular and/or flat cross section transverse to the flow direction S of the sample liquid 2.

The height H of the channel 3 indicated in FIGS. 1 & 4—therefore, the distance between the preferably parallel surfaces 4, 5 which border the channel 3—is at most 2000 μm, preferably, at most 500 μm, especially roughly 50 to 200 μm. The width of the channel 3 is preferable roughly 100 to 5000 μm, especially roughly 200 to 4000 μm. The height H of the channel 3 is much less, especially at least by a factor of 10 or 100, than the width of the channel 3. The holding volume of the channel 3 is preferably less than 1 ml, especially less than 100 μl, most preferably a maximum of 10 μl.

The device 1 therefore forms a microfluidic system. In particular, the device 1 is used for microfluidic diagnostics for medical or nonmedical purposes or other tests.

The channel 3 and the plane of its primary extension in the position of use run preferably at least essentially horizontally. Depending on the application or the design, however, another orientation is also possible, generally holding or filling of the channel 3 with sample liquid 2 is preferably caused or determined at least primarily due solely to capillary forces.

The reaction area 9 with a reagent which can be dissolved out by the sample liquid 3 and/or which reacts with it, and the preferably directly adjoining test area 10, is formed in the channel 3, preferably in succession on the same flat side 4 of the channel 3.

The reaction area 9 has a reagent which can preferably be dissolved by the sample liquid 2 for measuring a substance in the sample liquid 2 which is to be determined. In particular, the reagent is antibodies which are directed against the substance to be measured and which are bound to indicators (dyes, dye particles, for example, colloidal gold). The reagent is dissolved in the reaction area 9 when filled with the sample liquid 2. The substance to be determined, if it is contained in the sample liquid 2, then reacts with the antibody which is bound to the dye and forms especially a compound or a complex.

Alternatively or additionally, the reagent reacts with the analyzed substance and forms, especially, a reaction product even if the reagent is possibly not dissolved. The following statements with respect to the (dissolved) reagent therefore apply to the reaction product accordingly.

The test area 10 in the illustrated embodiment is provided with a preferably immobilized detection chemical which binds especially compounds or complexes of the substance to be determined and reagent or the reaction product. Unbound reagent and other components then flow with the sample liquid 2 farther into the collecting area 11, where they are taken up and thus backflow is prevented. In the test area 10, then, for example, the bound reagent can be optically determined and from that the presence and especially the concentration of the substance to be determined in the sample liquid 2 can be ascertained. Therefore, especially quantitative testing of the sample liquid 2 is enabled.

The device 1 in accordance with the invention has a means 12 for temporarily holding the sample liquid 2 in the reaction area 9 for dissolution and/or reaction of the reagent and/or in the test area 10.

The means 12 is preferably made such that the temporary holding can be established or cancelled by the sample liquid 2 itself, as described, for example, in European Patent Application EP 1 440 732 A1 and corresponding U.S. Patent Application Publication U.S. 2004/0206408 A1, or by a control liquid (not shown) or by selective venting, as is described, for example, in European Patent Application EP 1 440 732 A1 and corresponding U.S. Patent Application Publication 2004/0096358 A1, which is incorporated herein by reference. Preferably, the means 12 holds the sample liquid 2 for a predetermined time interval, optionally, only after complete filling of the reaction area 9, and/or up to complete filling of the reaction area 9.

In the illustrated embodiment, the means 12 has especially a control channel 13 which supplies the sample liquid 2 after or within a defined time to a liquid stop 14 which is located between the reaction area 9 and the test area 10 so that, then, the sample liquid 2 or the reaction volume of sample liquid 2 which is located in the reaction area 9 can cross the liquid stop 14 and can continue to flow into the test area 10.

If necessary, the device 1 has another means 12 for temporarily holding the sample liquid 2—especially the reaction volume of the sample liquid 2 which contains the dissolved reagent or the reaction product, which volume has flowed beforehand out of the reaction area 9 into the test area 10—in the test area 10 in order to enable determination as accurately or quantitatively as possible, in particular in order to enable at least essentially complete reaction or binding of the compounds or complexes of reagent and the substance to be analyzed or the reaction product on the detection chemical in the test area 10.

The other means 12 is made especially according to the aforementioned means 12. Accordingly, in turn, there is a control channel 13 which supplies the sample liquid 2 after or within a defined time to a liquid stop 14 which is located between the test area 10 and the downstream collecting area 11 so that, then, the sample liquid 2 or the reaction volume of sample liquid 2 which is located in the test area 10 can cross the liquid stop 14 and can continue to flow into the collecting area 11 and the sample liquid 2 flowing afterwards then can cause washing out of the unbound reagent or reaction product into the test area 10.

In the illustrated embodiment, the liquid stop 14 is formed especially by a groove-like or trough-like depression that extends transverse to the flow direction S. However, other designs are also possible. In particular, U.S. Pat. No. 5,458,852 discloses other design approaches to implementation of the means 16 which can be used alternatively or in addition.

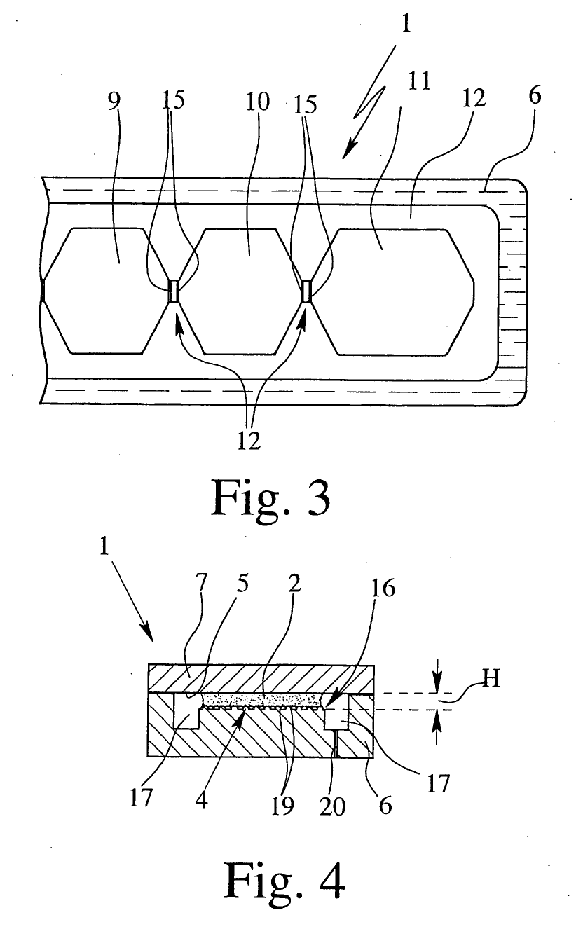

FIG. 3 is a top view corresponding to FIG. 2 showing the unfilled support 6 of a device 1 according to a second embodiment. Here, the means 12 have at least one preferably crosspiece-like barrier 15, especially two or more successive barriers 15, instead of a preferably groove-like or trough-like liquid stop 14. Thus, for example, corresponding temporary holding of the sample liquid 2 can be achieved if necessary.

In the second embodiment, in contrast to the first embodiment, the channel 3 does not have an essentially constant cross section. Rather the cross section of the channel 3 is reduced on the transition from the reaction area 9 to the test area 10 and/or in the transition from the test area 10 to the collecting area 11. This cross-sectional reduction is preferably achieved by uniform tapering of the liquid flow and subsequent spreading of the liquid flow. The means 2 or the barrier 15 is then located preferably in the area of the reduced cross section.

The indicated cross sectional reduction leads to a reduction of the volumetric flow through the channel 3 so that complete temporary holding may not be necessary. In particular a delay of the flow or reduction of the volumetric flow caused by the barriers 15 can if necessary be sufficient.

Furthermore, the device 1 as shown in the first or second embodiment has a means 16 for preventing the sample liquid 2 from shooting forward laterally of the flow direction S and/or for producing a flow front F of the sample liquid 2 (FIG. 1) and is straight or less curved with respect to the top view as shown in FIG. 2, or for producing a uniform or laminar flow.

In the illustrated embodiment, the means 15 is formed by the channel being made open at least on the lengthwise side. Laterally, the channel 3 is connected to a recess 17 which is made essentially groove-shaped or trough-shaped. Thus, a lateral liquid stop for the sample liquid 2—therefore, a flow barrier which cannot be overcome by capillary forces—is formed and the sample liquid 2 is routed along the open lengthwise sides in the channel 3 free of the side wall.

The recess 17 is preferably connected sharp-edged to the channel 3 as is indicated in FIGS. 1, 3 & 4. In the illustrated embodiment, the recess 17 is formed only in the support 6, as shown in FIGS. 1, 3 & 4; therefore, it extends essentially only down with respect to the lateral projection of the channel 3. However, the recess 17 can also selectively extend up or to either sides of the lateral projection of the channel 3, therefore especially up and down.

The recess 17, which is preferably rectangular in cross section, leads to an especially stepped or sudden increase in cross section such that the capillary forces are reduced in such a way that the indicated liquid stop for the sample liquid 2 is formed in the transition from the channel 3 to the recess 17. In particular, the height of the recess 17 is at least twice the height H of the channel 3.

The recess 17 extends in the illustrated embodiment along the open side of the channel 3, and in particular, is made to run peripherally around the channel 3 which is open on all sides.

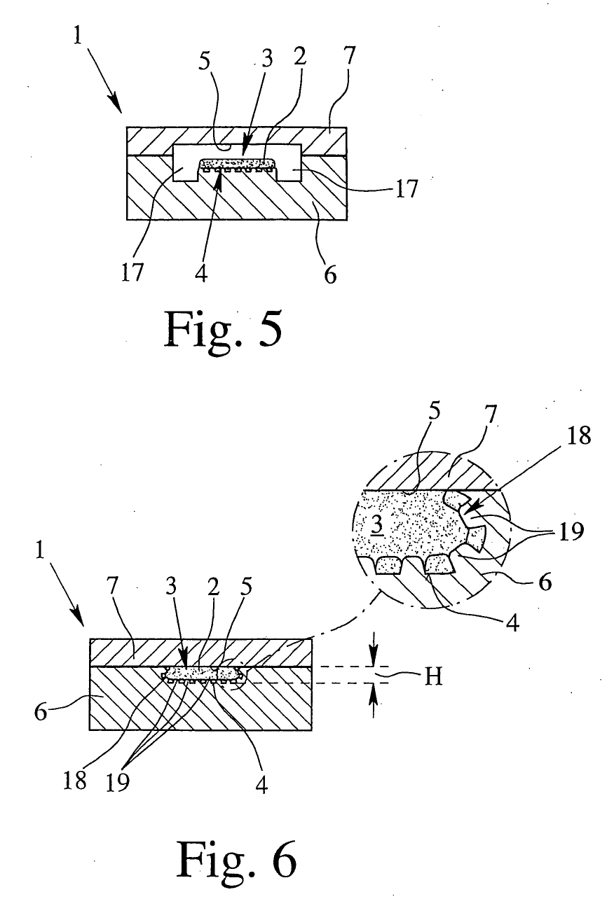

Corresponding guidance of the sample liquid 2 without a side wall for the channel 3 is also possible through the lateral recess 17 in the third embodiment of the device 1 which is shown in FIG. 5. Here, the sample liquid 2 is only routed on the bottom or flat side 4. Therefore, the sample liquid 2 is not in contact with the opposing flat side 5, as in the first embodiment. Instead, in the FIG. 5 embodiment, the cover 7 is accordingly relieved or the surface 4 is located accordingly deep in the support 6 in order to be able to maintain a sufficient distance to the then possibly flat cover 7. The thickness of the liquid film which is formed by the sample liquid 2 on the surface 4 depends especially on the wetting behavior and on the supplied, then especially metered amount of sample liquid 2. Preferably, then, the corresponding dimensions apply to the liquid film, as explained in the first embodiment for the channel 3.

FIG. 6 shows in a schematic section of a fourth embodiment of the device 1 in accordance with the invention, one side area of the channel 3 being broken-out and enlarged for the sake of illustration.

The means 16 for preventing the sample liquid 2 from shooting forward laterally to produce a less curved or straight flow front F and/or for producing a uniform or laminar flow can, alternatively or additionally, also have a side wall 18 which borders the channel 3 on the lengthwise side or on all sides, by forming the corresponding guide elements or delay structures, especially projections or elevations 19 or the like, the flow velocity or filling rate along the side wall 18 in the flow direction S reducing the filling rate, especially so that the filling rate of the sample liquid 2 on the edge does not exceed that in the middle area of the channel 3, but corresponds at least essentially to this. Alternatively or additionally to the guide elements or delay structures, the wetting of the side wall 18 can also be modified, especially reduced, such that the unwanted shooting of the sample liquid 2 forward along the side wall 18 is prevented.

In addition, with respect to possible embodiments for preventing the sample liquid 2 from shooting forward along the lengthwise side, reference is made to the possibilities which are described in this respect in European Patent Application EP 1 201 304 A2.

In the illustrated embodiments, the channel 3 has at least one guide element for influencing the filling with the sample liquid 2, especially for making it more uniform. In particular, the channel 3 preferably has regularly distributed elevations 19 as guide elements on the flat side 4 or optionally both flat sides 4, 5, as is shown in FIGS. 1, 2 and 4 to 6. They are arranged especially in series, transversely spaced, preferably extending lengthwise to the flow direction S. In this way, the result can be that the sample liquid 2 fills the channel 3 in rows—therefore row by row—and in this way, advances with an essentially straight liquid front F in the flow direction S. The means 16, if necessary, also comprises the indicated guide elements.

If necessary, the surface density, the distance and/or the size of the elevations 19 can vary, especially depending on the respective distance to the inlet, in order for the capillary forces to run as desired or to achieve compensation of flow resistances if necessary.

The elevations 19 are preferably made in the manner of a crosspiece, hump, or column, especially with a round or polygonal base. However, alternatively or additionally, there can also be depressions, such as troughs 8, or barriers 15 or other guide elements which run transversely or lengthwise to the flow direction S of the channel 3.

The groove-like trough 8, which is especially rectangular or half-round in cross section and which is preferably called for, has a considerably lower depth than the liquid stop 14 and the recess 17, and therefore, forms an only temporary liquid stop for making the liquid front F uniform. In this way, the result can be that the sample liquid 2 fills the trough 8 only after filling the channel 3 over the entire cross section and then fills the following channel area.

It should be emphasized that the combination of guidance of the sample liquid 2 without side walls and the guide elements achieves highly uniform filling of the channel 3, especially by capillary forces with a liquid front F which runs at least essentially in a straight line or perpendicular to the flow direction S.

Alternatively, the channel 3 can also be made in areas or overall at least essentially smooth or flat, therefore especially without guide elements, as indicated in FIG. 3.

The structuring or texturing of the reaction area 9 and/or of the test area 10, especially by guide elements, such as the elevations 19 or the like, facilitates the preferably uniform application of a chemical or the like, which then dries up, and in this way, for example, forms a dry chemical or immobilized chemical.

In addition, it is noted that the device 1 preferably has a vent 20 which is connected to the recess 17, as is indicated in FIG. 4. This very easily allows effective venting. This is conducive to uniform, bubble-free filling of the channel 3 with the sample liquid 2.

The interaction of the measures in accordance with the invention is explained in detail below, reference especially being made to the first embodiment or the representation as show in FIGS. 1 & 2.

After filling, the sample liquid 2 is routed by capillary forces in the channel 3 into the reaction area 9. In doing so, the sample liquid 2 in the channel 3—at least in the reaction area 9 and the test area 10—flows over the flat side and preferably at least essentially laminarly or with a uniform flow velocity or less curved or straight flow front F. This is achieved especially by the indicated means 16, especially in combination with the guide elements which are provided preferably at least in the reaction area 9 and/or the test area 10.

In the reaction area 9, the sample liquid 2 is temporarily held for a preferably predetermined time by the means 12. In the reaction area 9, the sample liquid 2 can dissolve the reagent which is preferably present as a dry chemical for determining the substance to be analyzed in the sample liquid 2 or can react with it. The reagent can be, for example, a conjugate which is formed from an antibody which binds the substance to be analyzed and from a dye particle or the like. The dissolved reagent or conjugate then bonds to the substance to be analyzed.

By temporarily holding the sample liquid 2, the reaction area 9 is filled with a defined reaction volume of sample liquid 2 so that the reagent dissolves at least essentially only in this reaction volume or reacts only with it. Temporary holding can thus prevent unwanted dispersion or extensive distribution of the reagent or a reaction product of the reagent in the sample liquid 2.

Furthermore, the time for temporary holding is preferably chosen such that the reagent is dissolved at least 90%, especially at least 95% or essentially more, especially in the reaction volume of the sample liquid 2 or reacts with it. If necessary, the dissolution or reaction can be supported by heat or other measures, such as application of a voltage or the like.

The reagent is preferably applied uniformly or in a predetermined concentration distribution on the flat side 4 in the reaction area 9. This can result in that—optionally with consideration of the filling process by the sample liquid 2—a distribution of the dissolved reagent or of the reaction product as fast and uniform as possible is achieved in the indicated reaction volume.

A distribution that is as uniform as possible in the reaction volume is also promoted by the fact that the reagent is located on the flat side 4 of the channel 3 and that due to the comparatively low channel height H, accordingly, rapid diffusion, and thus, a uniform distribution of the dissolved reagent or of the reaction product in the reaction volume can be achieved.

After defined dissolution or reaction, the means 12 releases the sample liquid 2 so that the sample liquid 2—especially the defined reaction volume—can continue to flow from the reaction area 9 into the test area 10. As a result of these measures and especially of the means 16, in turn especially low dispersion of the dissolved reagent and of the compounds or complexes formed from the reagent and the substance to be analyzed out of the reaction volume can be prevented. In particular, the result is that the reagent or the reaction product flows or is conveyed at least 90%, preferably 95% or more together with the reaction volume into the test area 10.

In the test area 10, then the sample liquid 2 or the reaction volume is, if necessary, again temporarily held in order to support the testing desired at the time, especially the binding of the complexes or compounds formed from the reagent and the substance to be analyzed, which binding is provided in the illustrated embodiment, on the detection chemical which is immobilized in the test area 10 preferably on the flat side 4. However, this temporary holding in the test area 10 is not absolutely essential so that the other means 12 which is assigned to the test area 10 can optionally be omitted, is preferred.

The detection chemical which is provided is especially an immobilized dry chemical, for example, a catcher antibody, which catches the compounds or complexes of the reagent and the substance to be analyzed and in this way binds them.

In addition, other testing steps can be carried out by means of other, additional chemicals in the test area 10 or in several successive test areas 10. For example, it can also be tested whether the analyzed substance to be determined is contained at all in the sample liquid 2.

The test area 10 is preferably connected directly to the reaction area 9 so that unwanted dispersion of the reagent or of the compounds or complexes formed by the reagent with the substance to be analyzed or of other reaction products out of the reaction volume into other areas of the sample liquid 2 is at least essentially prevented or minimized. Because the test area 10 is preferably directly connected to the reaction area 9, specifically the dead volume, and thus the dispersion are minimized.

Due to the flat cross section of the channel 3, the reaction area 9 and/or the test area 10 can be made comparatively short in the flow direction S so that overall very short flow paths, and thus, low dispersion can be achieved. In particular, the reaction area 9 and/or the test area 10 is made only just as long as or shorter than the width of the channel 3.

In particular, the dispersion which can be achieved in accordance with the invention is small in the test area 10 such that the concentration of the reagent or reaction product in the reaction volume in the test area 10 varies by a maximum 10%, preferably less than 5%, quite preferably at most 3%.

The comparatively short height H of the channel 3 and the preferred arrangement of the detection chemical on the flat side, especially the flat side 4, lead to the complexes or compounds of the reagent and substance to be analyzed which are contained in the reaction volume, or other reaction products being able to be bound very quickly or with high efficiency by the detection chemical or the like.

In a subsequent washing step, the sample liquid 2 continues to flow into the collecting area 11 which can optionally be provided with an absorptive material and/or guide elements such as elevations 19 in order to more or less absorb the sample liquid 2 and to prevent backflow. The volume of the collecting area 11 is larger than the reaction volume preferably at least by a factor of 2 or 5 in order to achieve efficient washout of the unbound reagent, unbound reaction products and/or other possibly disruptive particles or substances from the test area 10.

Then, the determination of the reagent or reaction product bound in the test area 10 takes place preferably optically, for example, spectroscopically. This is possible especially by the reagent or reaction product being made, for example, as a conjugate from an antibody and a dye complex, dye particles, or the like. Then, especially the concentration of the substance to be analyzed in the sample liquid 2 can be determined from the number or concentration of bound complexes or compounds. Consequently, the device 1 of the invention and the above described process allow testing of a sample liquid 2 which is much more accurate than conventional test filter strips, especially quantitative determination of the substance to be analyzed or optionally also several substance to be analyzed in the sample liquid 2.

What is claimed is:

1. Device for testing a sample liquid, comprising:
a channel adapted for holding and conveying a sample liquid by capillary forces and which has a flat side over which the sample liquid flows,
a reaction area formed by the channel and having a soluble or reacting reagent on the flat side, the reaction area being completely fillable with a sample liquid so that a reaction volume is definable by the sample liquid,
a test area formed by the channel and which is downstream of the reaction area,
means for temporarily holding the sample liquid in the reaction area for a time sufficient for the reagent to be at least 90% soluble or reacted with the sample liquid in the defined reaction volume, and
means for providing the sample liquid with a generally straight flow front,
wherein the dissolved reagent or a reaction product of the reagent with the sample liquid is conveyable together with the reaction volume into the test area.

2. Device as claimed in claim 1, wherein the channel has an at least essentially constant cross section for the sample liquid at least from the reaction area to the test area.

3. Device as claimed in claim 1, wherein the height of the channel is smaller than the width of the channel by a factor of 10.

4. Device for testing a sample liquid, comprising:
a channel which conveys and holds a sample liquid by capillary forces and which has a flat side over which the sample liquid flows laminarly,
a reaction area formed by the channel and having at least one of a soluble and a reacting reagent on the flat side,
a test area which is formed by the channel and which is downstream of the reaction area,
wherein at least one of the following conditions is satisfied:
at least one of the reaction area, test area, and channel has an at least essentially constant cross section,
the channel has a height that is smaller than a width of the channel by a factor of at least 10,
at least one of the reaction area and test area have a length that is at most equal to the width thereof.

5. Device as claimed in claim 4, wherein the device has a means for temporarily holding the sample liquid in the reaction area for dissolving or reacting the reagent.

6. Device as claimed in claim 4, wherein the device has a means for preventing the sample liquid from shooting forward laterally in the flow direction and/or for producing a straight or less curved flow front of the sample liquid.

7. Device as claimed in claim 4, wherein the reaction area is completely fillable with the sample liquid so as to provide a defined reaction volume of the sample liquid, wherein the reagent is at least 90% soluble or reactable in the defined reaction volume of the sample liquid, and wherein at least 90% of the dissolved reagent or a reaction product of the reagent are conveyable together with the reaction volume into the test area.

8. Device as claimed in claim 1, wherein the channel is sized and configured for enabling the sample liquid to be conveyed in the channel solely by capillary forces.

9. Device as claimed in claim 1, wherein the channel is bordered by two opposing flat sides between which the sample liquid can be guided and with which the sample liquid is in contact.

10. Device as claimed in claim 1, wherein the reagent is present as a dry chemical and that is dissolvable by the sample liquid.

11. Device as claimed in claim 1, wherein the reaction area and the test area have at least essentially the same size.

12. Device as claimed in claim 1, wherein the test area is directly connected to the reaction area, and wherein the means for temporarily holding the sample liquid is one of a liquid stop or barrier located between the reaction area and the test area.

13. Device as claimed in claim 1, wherein the test area has an immobilized detection chemical for detection of compounds or complexes which have been formed from the reagent and the substance to be determined in the sample liquid.

14. Device as claimed in claim 1, wherein the channel has a collecting area downstream of the test area for the sample liquid, and wherein the volume of the collecting area is larger than the reaction volume by at least a factor of 2.

15. Device as claimed in claim 1, wherein the means for temporarily holding the sample liquid is made such that the temporary holding can be established or cancelled by one of the sample liquid itself, a control liquid, and selective venting.

16. Device as claimed in claim 1, wherein the means for temporarily holding the sample liquid has a control channel which supplies the sample liquid to a liquid stop on the end of the reaction area so that the sample liquid can cross the liquid stop and the reaction volume can continue to flow from the reaction area into the test area.

17. Device as claimed in claim 1, wherein the means for temporarily holding the sample liquid is adapted to stop the sample liquid for one of a predetermined time interval and until complete filling of the reaction area.

18. Device as claimed in claim 1, wherein the means for providing the sample liquid with a generally straight flow front is formed by the channel being open at least on lengthwise sides thereof so that a lateral liquid stop for the sample liquid is formed in the channel and the sample liquid can be routed in the channel free of the side wall.

19. Device as claimed in claim 1, wherein the means for providing the sample liquid with a generally straight flow front has a recess which is laterally connected preferably sharp-edged to form a liquid stop.

20. Device as claimed in claim 19, wherein the recess runs peripherally and surrounds the channel on all sides.

21. Device as claimed in claim 1, wherein peripherally, the channel is open laterally.

22. Device as claimed in claim 1, wherein the means for providing the sample liquid with a generally straight flow front has a side wall which prevents the sample liquid from shooting forward and which is one of curved, rounded and provided with guide elements.

23. Device as claimed in claim 1, wherein the device is made such that a certain volume of the sample liquid can be metered into the channel.

24. Device as claimed in claim 1, wherein the device is made as a platform which is provided with at least one microstructure for forming a channel.

25. Device as claimed in claim 4, wherein the channel is sized and configured for conveying the sample liquid solely by capillary forces.

26. Device as claimed in claim 4, wherein the channel is bordered preferably solely by two opposing flat sides between which the sample liquid can be guided and with which the sample liquid is in contact.

27. Device as claimed in claim 4, wherein the reagent is present as a dry chemical and is dissolvable by the sample liquid.

28. Device as claimed in claim 4, wherein the reaction area and the test area have at least essentially the same size.

29. Device as claimed in claim 4, wherein the test area is directly connected to the reaction area; and wherein the means for temporarily holding the sample liquid comprises a liquid stop or barrier located between the reaction area and the test area.

30. Device as claimed in claim 4, wherein the test area has an immobilized detection chemical for detection of compounds or complexes which have been formed from the reagent and a substance to be analyzed in the sample liquid.

31. Device as claimed in claim 4, wherein the channel has a collecting area for the sample liquid downstream of the test area, wherein the volume of the collecting area is larger than the reaction volume at least by a factor of 2.

32. Device as claimed in claim 5, wherein the means for temporarily holding the sample liquid is made such that the temporary holding can be established or cancelled by one of the sample liquid itself, a control liquid, and selective venting.

33. Device as claimed in claim 5, wherein the means for temporarily holding the sample liquid has a control channel which supplies the sample liquid to a liquid stop on the end of the reaction area so that the sample liquid can cross the liquid stop and the reaction volume can continue to flow from the reaction area into the test area.

34. Device as claimed in claim 5, wherein the means for temporarily holding the sample liquid is adapted to stop the sample liquid for one of a predetermined time interval and complete filling of the reaction area.

35. Device as claimed in claim 5, wherein the means for providing the sample liquid with a generally straight flow front is formed by the channel being open at least on lengthwise sides thereof so that a lateral liquid stop for the sample liquid is formed in the channel and the sample liquid can be routed in the channel free of the side wall.

36. Device as claimed in claim 5, wherein the means for providing the sample liquid with a generally straight flow front has a recess which is laterally connected to form a liquid stop.

37. Device as claimed in claim 36, wherein the recess runs peripherally around the channel on all sides.

38. Device as claimed in claim 4, wherein the channel is peripherally open.

39. Device as claimed in claim 6, wherein the means for providing the sample liquid with a generally straight flow front has a side wall which prevents the sample liquid from shooting forward and which is provided with one of a curved or rounded cross section and guide elements.

40. Device as claimed in claim 4, wherein the device is made such that a certain volume of the sample liquid can be metered into the channel.

41. Device as claimed in claim 4, wherein the device is a platform which is provided with at least one microstructure for forming a channel.

42. Process for testing a sample liquid, comprising the steps of:
causing a sample liquid to flow laminarly by capillary forces over a flat side of a channel to completely fills a reaction area on the flat side that has with a soluble or reacting reagent so as to provide a defined reaction volume of the sample liquid,
slowing or temporarily stopping the reaction volume in the reaction area for dissolving or reacting the reagent, and
causing the sample liquid to flow with an at least generally straight flow front from the reaction area into the test area.

43. Process as claimed in claim 42, dissolving or reacting at least 90% of the reagent in the defined reaction volume of the sample liquid, and causing at least 90% of the dissolved reagent or a reaction product of the reagent to flow together with the reaction volume into the test area which is formed by the channel and which is located downstream of the reaction area.

44. Process as claimed in claim 42, wherein the sample liquid is guided in the channel on the flat side without a side wall in order to achieve an at least essentially straight liquid front.

45. Process as claimed in claim 42, wherein the reaction volume in the test area is held temporarily until at least 95% of the complexes, compounds or reaction products formed from the reagent and the substance to be determined in the sample liquid are bound by a detection chemical in the test area.

46. Process as claimed in claim 42, comprising the further step of flushing the test area with sample liquid after flowing through the reaction volume before testing or determination of the reaction products, complexes or compounds from the reagent and the substance to be determined takes place.

47. Process as claimed in claim 1, wherein the device comprises further meas for temporarily holding the sample the sample liquid or reaction volume in the test area.

48. Process as claimed in claim 4, wherein the device comprises further means for temporarily holding the sample the sample liquid in the test area.

49. Device as in claim 1, wherein at least 90% of the dissolved reagent or a reation product of the reagent are conveyable together with the reaction volume into the test area.

50. Device as claimed in claim 1, wherein a small dispersion is achievable such that a concentration of the reagent or a reaction product of the reagent in the reaction volume varies by a maximum 10% in the test area.
